(19) United States
(12) Patent Application Publication
(10) Pub. No.: US 2024/0381375 A1
(43) Pub. Date: Nov. 14, 2024

(54) BEAM-BASED FULL DUPLEX OPPORTUNITY ANNOUNCEMENTS

(71) Applicant: QUALCOMM Incorporated, San Diego, CA (US)

(72) Inventors: Yan ZHOU, San Diego, CA (US); Hemant SAGGAR, San Diego, CA (US)

(21) Appl. No.: 18/314,734

(22) Filed: May 9, 2023

(51) Int. Cl. H04W 72/25; H04L 5/14; H04W 72/044

(52) U.S. Cl. CPC H04W 72/25; H04L 5/14; H04W 72/046

(57) ABSTRACT

Various aspects of the present disclosure generally relate to wireless communication. In some aspects, a first user equipment (UE) may reserve a first set of sidelink resources for a first transmission to a second UE. The UE may transmit a beam-based full duplex (FD) opportunity announcement associated with a second transmission that at least partially overlaps the first transmission in time, the beam-based FD opportunity announcement indicating a first transmission beam associated with the third UE. Numerous other aspects are described.

### FIELD OF THE DISCLOSURE

Aspects of the present disclosure generally relate to wireless communication and to techniques and apparatuses for providing beam-based full duplex opportunity announcements.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first user equipment (UE) for wireless communication. The first user equipment may include one or more memories and one or more processors coupled to the one or more memories. The one or more processors may be configured to reserve a first set of sidelink resources for a first transmission to a second UE. The one or more processors may be configured to transmit a beam-based full duplex (FD) opportunity announcement associated with a second transmission that at least partially overlaps the first transmission in time, the beam-based FD opportunity announcement indicating a first transmission beam associated with the third UE.

Some aspects described herein relate to a third UE for wireless communication. The third user equipment may include one or more memories and one or more processors coupled to the one or more memories. The one or more processors may be configured to receive, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE. The one or more processors may be configured to transmit the second transmission based on receiving the beam-based FD opportunity announcement.

Some aspects described herein relate to a method of wireless communication performed by a first UE. The method may include reserving a first set of sidelink resources for a first transmission to a second UE. The method may include transmitting a beam-based FD opportunity announcement associated with a second transmission, by a third UE to the first UE, that at least partially overlaps the first transmission in time, the beam-based FD opportunity announcement indicating a first transmission beam associated with the third UE.

Some aspects described herein relate to a method of wireless communication performed by third UE. The method may include receiving, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE. The method may include transmitting the second transmission based on receiving the beam-based FD opportunity announcement.

Some aspects described herein relate to a non-transitory computer-readable medium that stores a set of instructions for wireless communication by a first UE. The set of instructions, when executed by one or more processors of the UE, may cause the UE to reserve a first set of sidelink resources for a first transmission to a second UE. The set of instructions, when executed by one or more processors of the UE, may cause the UE to transmit a beam-based FD opportunity announcement associated with a second transmission that at least partially overlaps the first transmission in time, the beam-based FD opportunity announcement indicating a first transmission beam associated with the third UE.

Some aspects described herein relate to a non-transitory computer-readable medium that stores a set of instructions for wireless communication by a third UE. The set of instructions, when executed by one or more processors of the UE, may cause the UE to receive, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE. The set of instructions, when executed by one or more processors of the UE, may cause the UE to transmit the second transmission based on receiving the beam-based FD opportunity announcement.

Some aspects described herein relate to an apparatus for wireless communication. The apparatus may include means for reserving a first set of sidelink resources for a first transmission to a first UE. The apparatus may include means for transmitting a beam-based FD opportunity announcement associated with a second transmission that at least partially overlaps the first transmission in time, the beam-based FD opportunity announcement indicating a first transmission beam associated with the apparatus.

Some aspects described herein relate to an apparatus for wireless communication. The apparatus may include means for receiving, from a first UE, a beam-based FD opportunity announcement associated with a second transmission, by the apparatus to the first UE, that at least partially overlaps a first transmission, from the first UE to a second UE, in time, the beam-based FD opportunity announcement indicating an allowed transmission beam associated with the apparatus. The apparatus may include means for transmitting the second transmission based on receiving the beam-based FD opportunity announcement.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink and access link communications, in accordance with the present disclosure.

FIG. 5 is a diagram illustrating an example associated with beam-based full duplex opportunity announcements, in accordance with the present disclosure.

FIGS. 6A and 6B are diagrams illustrating examples associated with autonomous determination of sidelink full duplex via beam-based sensing, in accordance with the present disclosure.

FIG. 7 is a diagram illustrating an example process performed, for example, by a first UE, in accordance with the present disclosure.

FIG. 8 is a diagram illustrating an example process performed, for example, by a third UE, in accordance with the present disclosure.

FIG. 9 is a diagram of an example apparatus for wireless communication, in accordance with the present disclosure.

### DETAILED DESCRIPTION

Various aspects relate generally to sidelink full duplex FD communications. Some aspects more specifically relate to providing beam-based FD opportunity announcements. For example, in some aspects, an FD capable user equipment (UE) may transmit a beam-based FD opportunity announcement. In some aspects, the beam-based FD opportunity announcement may indicate an allowed transmission beam on which an additional UE may transmit a communication to the UE during an FD communication operation. In some aspects, the beam-based FD opportunity announcement may indicate one or more transmission parameters that may be used by the additional UE.

Particular aspects of the subject matter described in this disclosure can be implemented to realize one or more of the following potential advantages. In some examples, the described techniques can be sued to enable informing UEs of opportunities for FD sidelink communications as well as beams that may be used for those communications, thereby reducing the likelihood of missed communications and interference, which may positively impact sidelink performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

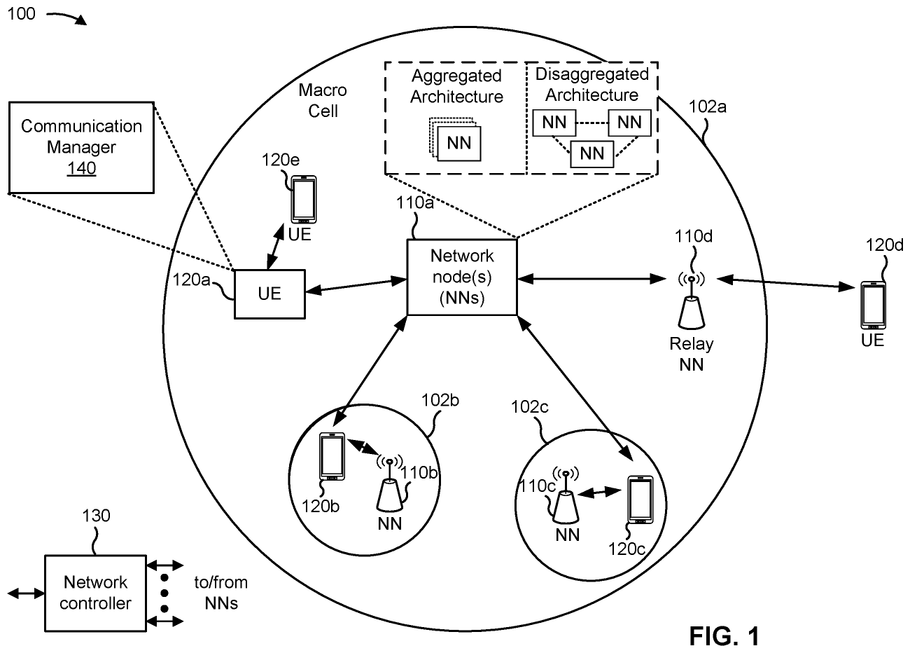

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell May be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., the UE 120) may include a communication manager 140. As described in more detail elsewhere herein, the communication manager 140 may reserve a first set of sidelink resources for a first transmission to a second UE; and transmit a beam-based FD opportunity announcement associated with a second transmission that at least partially overlaps the first transmission in time, the beam-based FD opportunity announcement indicating a first transmission beam associated with the third UE. Additionally, or alternatively, the communication manager 140 may perform one or more other operations described herein.

In some aspects, a third UE (e.g., the UE 120) may include a communication manager 140. As described in more detail elsewhere herein, the communication manager 140 may receive, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE; and transmit the second transmission based on receiving the beam-based FD opportunity announcement. Additionally, or alternatively, the communication manager 140 may perform one or more other operations described herein.

As indicated above, FIG. 1 is provided as an example. Other examples may differ from what is described with regard to FIG. 1.

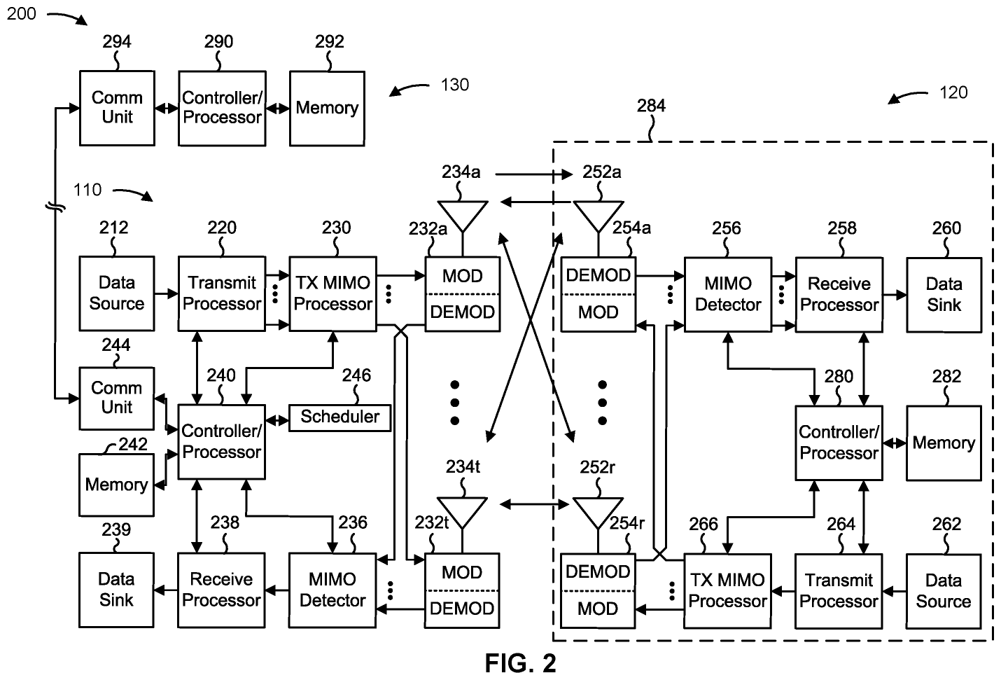

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

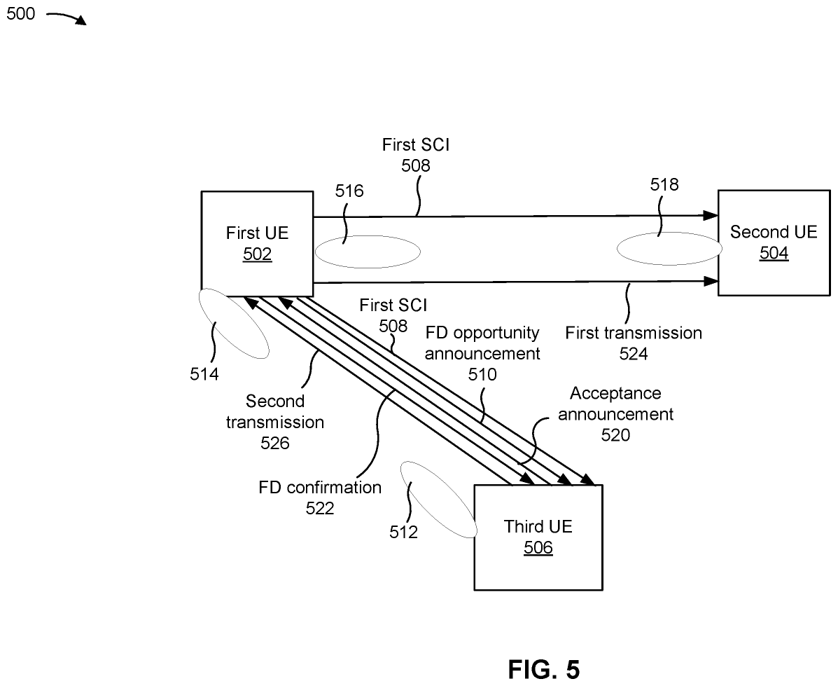

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

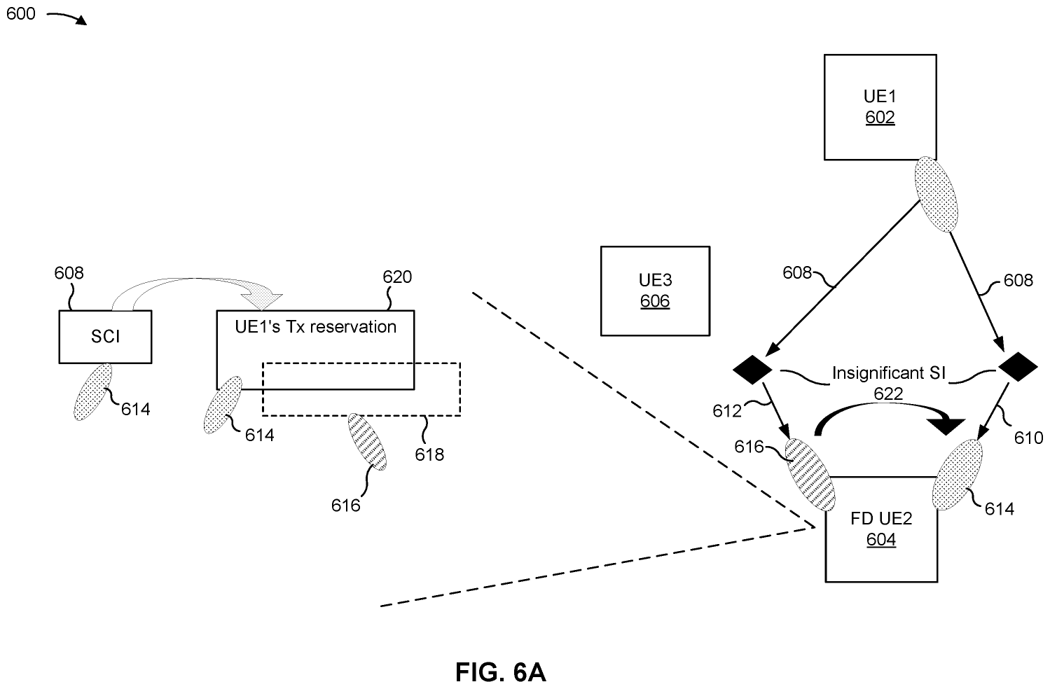

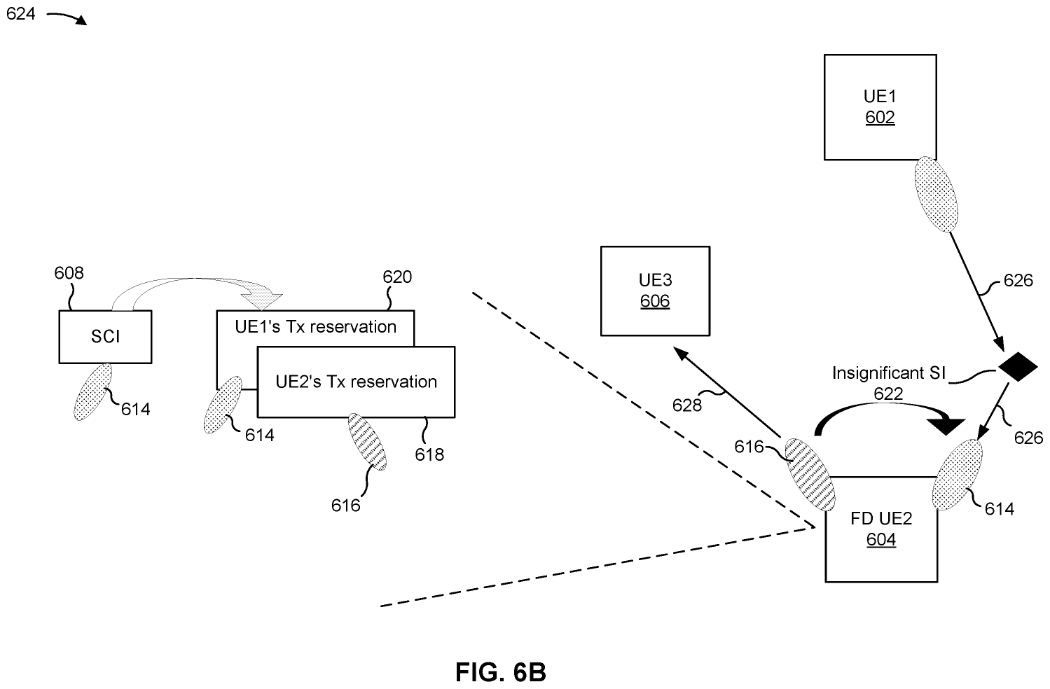

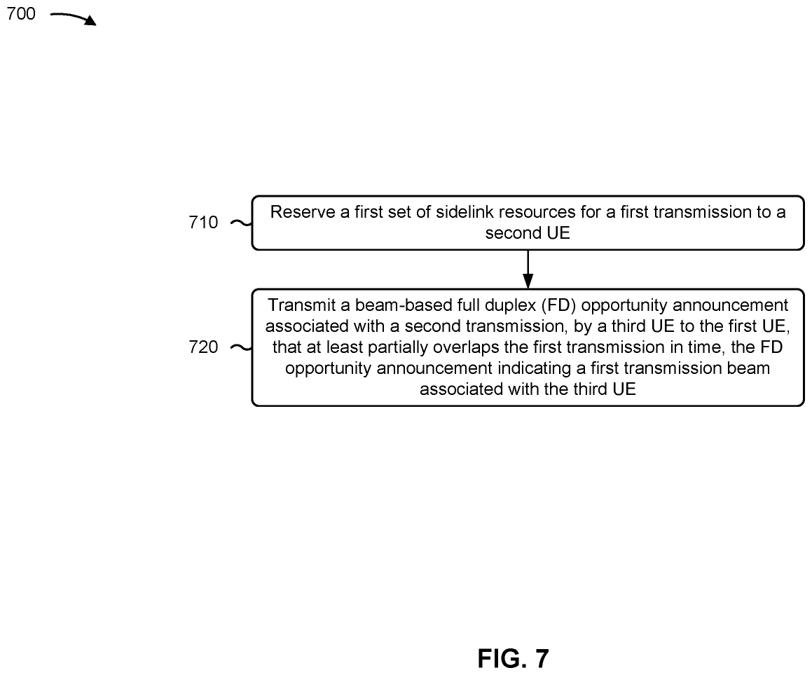

The controller/processor 240 of the network node 110, the controller/processor 280 of the UE 120, and/or any other component(s) of FIG. 2 may perform one or more techniques associated with beam-based FD opportunity announcements, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a first UE (e.g., UE 120) includes means for reserving a first set of sidelink resources for a first transmission to a second UE; and/or means for transmitting a beam-based FD opportunity announcement associated with a second transmission, by a third UE to the first UE, that at least partially overlaps the first transmission in time, the beam-based FD opportunity announcement indicating a first transmission beam associated with the third UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a third UE (e.g., UE 120) includes means for receiving, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE; and/or means for transmitting the second transmission based on receiving the beam-based FD opportunity announcement. The means for the third UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

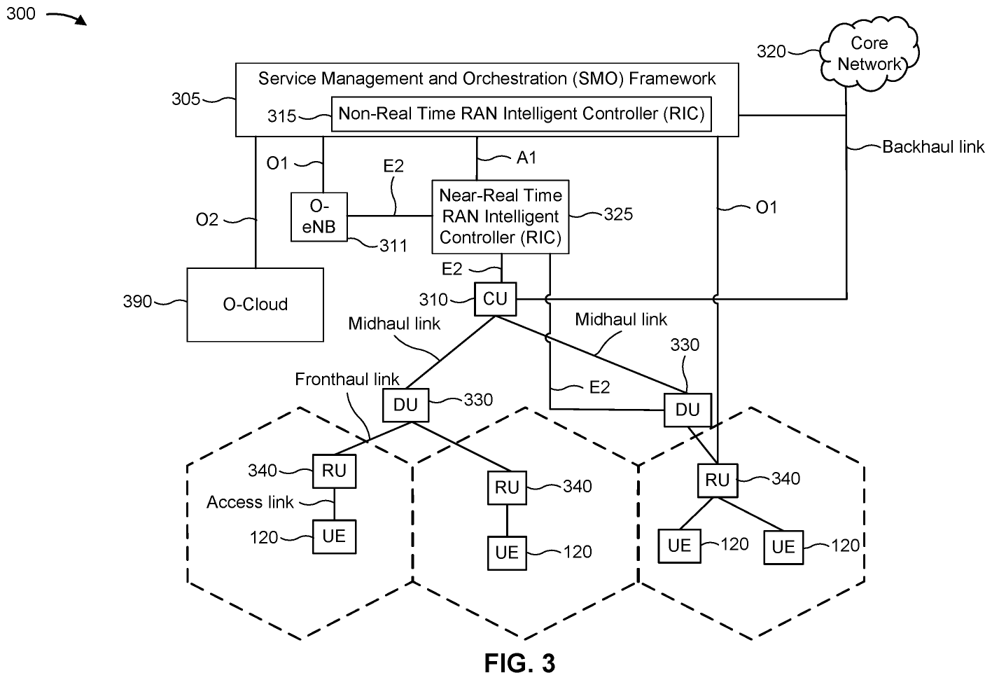

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

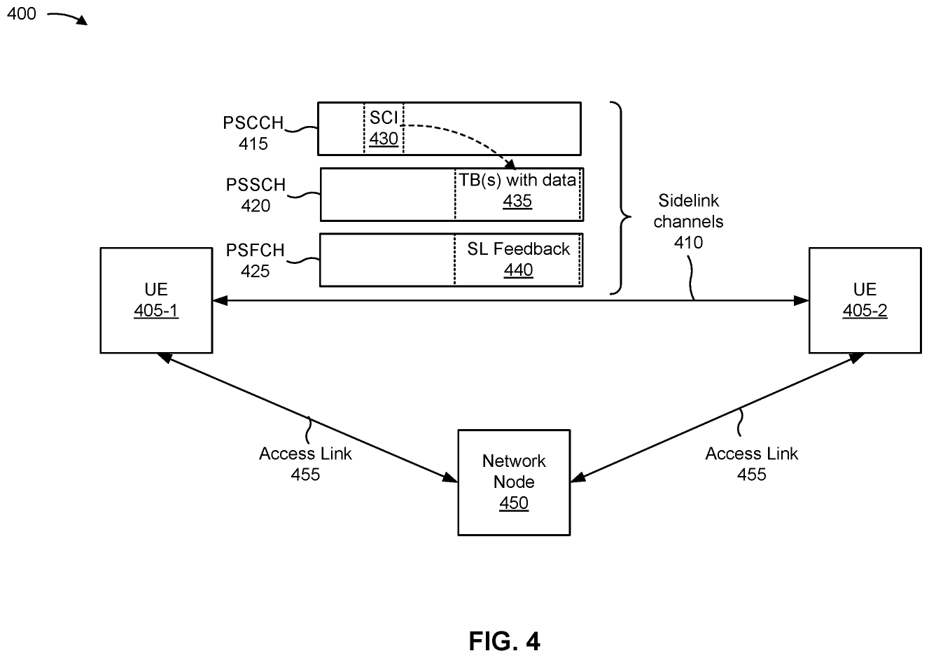

FIG. 4 is a diagram illustrating an example 400 of sidelink and access link communications, in accordance with the present disclosure. As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHZ band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a PSCCH 415, a PSSCH 420, and/or a PSFCH 425. The PSCCH 415 may be used to communicate control information, similar to a PDCCH and/or a PUCCH used for cellular communications with a BS 110 via an access link or an access channel. The PSSCH 420 may be used to communicate data, similar to a PDSCH and/or a PUSCH used for cellular communications with a BS 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement/negative acknowledgement (ACK/NACK) information), TPC, and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an ACK in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “sidelink HARQ feedback information”).

A HARQ-ACK bit may be referred to as an ACK/NACK and/or a HARQ-ACK and may be associated with a HARQ process. “HARQ process” refers to the determination of whether to report an ACK or NACK associated with a transmission, a time resource associated with the transmission (e.g., a symbol or a slot), and/or a frequency resource associated with the transmission (e.g., a resource block (RB), a subchannel, a channel, a bandwidth, and/or a bandwidth part). Accordingly, an ACK/NACK may be interchangeably referred to as being associated with a transmission, a time resource, a frequency resource, and/or a HARQ process.

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a CSI report trigger.

In some aspects, the one or more sidelink channels 410 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 430) may be transmitted in sub-channels using specific RBs across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405-1 may operate using a sidelink transmission mode (e.g., Mode 1) where resource selection and/or scheduling is performed by a BS 110 (e.g., a base station, a CU, or a DU). For example, the UE 405-1 may receive a grant (e.g., in DCI or in an RRC message, such as for configured grants) from the BS 110 (e.g., directly or via one or more network nodes) for sidelink channel access and/or scheduling. In some aspects, a UE 405-1 may operate using a transmission mode (e.g., Mode 2) where resource selection and/or scheduling is performed by the UE 405-1 (e.g., rather than a BS 110). In some aspects, the UE 405-1 may perform resource selection and/or scheduling by sensing channel availability for transmissions. For example, the UE 405-1 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405-1 may perform resource selection and/or scheduling using SCI 430 received in the PSCCH 415, which may indicate occupied resources and/or channel parameters. Additionally, or alternatively, the UE 405-1 may perform resource selection and/or scheduling by determining a channel busy ratio (CBR) associated with various sidelink channels, which may be used for rate control (e.g., by indicating a maximum number of resource blocks that the UE 405-1 can use for a particular set of subframes).

In the transmission mode where resource selection and/or scheduling is performed by a UE 405-1, the UE 405-1 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405-1 may generate a sidelink grant that indicates one or more parameters for SPS, such as a periodicity of a sidelink transmission. Additionally, or alternatively, the UE 405-1 may generate a sidelink grant for event-driven scheduling, such as for an on-demand sidelink message.

As shown, a network node 450 may communicate with the UE 405-1 and/or the UE 405-2 (e.g., directly or via one or more network nodes), such as via an access link 455. A direct link between the UEs 405-1 and 405-2 (e.g., via a PC5 interface) may be referred to as a sidelink, and a direct link between a network node 450 and a UE 405-1 or 405-2 (e.g., via a Uu interface) may be referred to as an access link. Sidelink communications may be transmitted via the sidelink, and access link communications may be transmitted via the access link. An access link communication may be either a downlink communication (from the network node 450 to the UE 405-1 or 405-2) or an uplink communication (from a UE 405-1 or 405-2 to the network node 450).

Additionally, or alternatively, the UE 405-1 and/or 405-2 can perform resource selection and/or scheduling using SCI 430 received in the PSCCH 415, which can indicate occupied resources and/or channel parameters. Additionally, or alternatively, the UE 405-1 and/or 405-2 can perform resource selection and/or scheduling by determining a CBR associated with various sidelink channels, which can be used for rate control (e.g., by indicating a maximum number of resource blocks that the UE 405-1 and/or 405-2 can use for a particular set of subframes).

In the second transmission mode, the UE 405-1 and/or 405-2 can generate sidelink grants, and can transmit the grants in SCI 430. A sidelink grant can indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), and/or one or more subframes to be used for the upcoming sidelink transmission. In some aspects, a UE 405-1 and/or 405-2 can generate a sidelink grant that indicates one or more parameters for SPS, such as a periodicity of a sidelink transmission. Additionally, or alternatively, the UE 405-1 and/or 405-2 can generate a sidelink grant for event-driven scheduling, such as for an on-demand sidelink message.

In some cases, a UE 405-1 may communicate directly with one or more other UEs 405-2 via sidelink channels in a half-duplex manner. That is, a UE 405-1 may communicate with another UE 405-2 in one direction at a time. For example, the UE 405-1 may transmit, to the other UE 405-2, data at a first occasion and receive, from the other UE 405-2, data at a second occasion. For example, a resource reservation at a future occasion may be explicitly signaled by a first UE 405-1 to a second UE 405-2 in SCI. The second UE 405-2 may avoid the reserved resources as well as the resource in which the second UE 405-2 receives the resource reservation for choosing resources to transmit to the first UE 405-1. In aspects, the half-duplex communications supported for sidelink transmissions may provide undesirable spectral efficiency, data rates, and/or latencies. Accordingly, FD communication may be supported for UEs over sidelink channels. In some cases, sub-band FD (SBFD) resource management for sidelink communications may provide signaling and procedures to enable the coexistence between half-duplex UEs and FD UEs. As used herein, an SBFD system may refer to a wireless communication system where some UEs are able to concurrently perform transmission and reception in separate sub-bands or sub-channels within one or more carriers. SBFD resource management can enable a UE to perform resource selection to communicate with another UE in an FD manner. As an example, a first UE, which is FD capable, may provide one or more second UEs, which may be FD capable, with the receive resources that the first UE can use to perform reception simultaneously with transmissions to the second UEs. In some cases, single-frequency full-duplex (SFFD) may be possible at a UE where the UE is able to transmit and receive in fully or partially overlapping sub-bands or sub-channels. SFFD may also be called by other names such as full-band-full-duplex.

In mode 2 sidelink, however, for a given resource reservation from a first UE, a second UE may not be aware that the first UE can simultaneously receive while transmitting on its reservation. Additionally, the feasibility of FD at the first UE may vary with channel as well as transmission parameters associated with the first UE and the second UE. In some cases, FD at the first UE may be feasible with the second UE due to FD compatibility between the beams of first and second UE but not with the beams of other UEs. In such cases, if the second UE is unaware of the feasibility of FD, FD communications may be missed and/or cause unnecessary interference, negatively impacting sidelink performance.

Various aspects of the techniques and apparatuses described herein may be associated with providing beam-based FD opportunity announcements. For example, in some aspects, an FD capable UE may transmit a beam-based FD opportunity announcement, e.g. in SCI. In some aspects, the beam-based FD opportunity announcement may indicate an allowed transmission beam on which an additional UE may transmit a communication to the UE during an FD communication operation. In some aspects, the beam-based FD opportunity announcement may indicate one or more transmission parameters that may be used by the additional UE. In this way, some aspects facilitate informing UEs of opportunities for FD sidelink communications as well as beams that may be used for those communications, thereby reducing the likelihood of missed communications and interference, which may positively impact sidelink performance.

As indicated above, FIG. 4 is provided as an example. Other examples may differ from what is described with regard to FIG. 4.

FIG. 5 is a diagram illustrating an example 500 associated with beam-based full duplex opportunity announcements, in accordance with the present disclosure. As shown, a first UE 502, a second UE 504, and a third UE 506 may communicate with one another over a sidelink network (e.g., as described above in connection with FIG. 4). In some aspects, the UEs 502, 504, and 506 may be, be similar to, include, or be included in the UEs 405-1 and/or 405-2 depicted in FIG. 4, and/or the UE 120 depicted in FIGS. 1-3.

The first UE 502 may reserve a first set of sidelink resources for a first transmission to the second UE 504. For example, as shown by reference number 508, the first UE 502 may transmit first SCI. The first SCI may include a reservation of the first set of sidelink resources for the first transmission to the second UE 504. The first SCI 508 may be broadcast or groupcast and, thus, may be received by other UEs such as the third UE 506, indicating to the other UEs the reservation for the transmission from the first UE 502 to the second UE 504. As shown by reference number 510, the first UE 502 may transmit a beam-based FD opportunity announcement. The beam-based FD opportunity announcement may be associated with a second transmission, by the third UE 506 to the first UE 502, that at least partially overlaps the first transmission in time. The beam-based FD opportunity announcement may indicate that the third UE 506 may transmit to the first UE 502 using resources that overlap in time with the first set of sidelink resources, due to the FD capability of first UE 502. In some aspects, utilizing the FD opportunity by the third UE 506 may free up sidelink resources for other transmissions and increase network efficiency or reduce latency.

In some aspects, the beam-based FD opportunity announcement may indicate a first transmission beam 512 associated with the third UE 506. In some aspects, the first UE 502 may transmit the beam-based FD opportunity announcement via at least one of an SCI part 1, an SCI part 2, a medium access control (MAC) control element (MAC CE), or a radio resource control (RRC) message. In some aspects, the first SCI may include the beam-based FD opportunity announcement. In some aspects, the first UE 502 may transmit a second SCI that includes the beam-based FD opportunity announcement that is associated with the first set of sidelink resources reserved in the first SCI.

In some aspects, the beam-based FD opportunity announcement may indicate the third UE 506 and/or one or more additional UEs. For example, the beam-based FD opportunity announcement may indicate the third UE based on the beam-based FD opportunity announcement including a UE identifier (ID) associated with the third UE. In some aspects, the beam-based FD opportunity announcement may indicate the third UE based on a destination ID associated with the first transmission, the destination ID comprising a UE ID of the second UE, where a UE ID of the third UE is the same as the UE ID of the second UE. For example, in some cases, the second UE 504 and the third UE 506 may be the same UE.

In some aspects, the beam-based FD opportunity announcement may indicate neighbour UE ID(s) whose transmission is allowed to partially and/or fully overlap with the reservation of the first transmission at least in time. In some aspects, the UE ID May be implied by the data destination ID scheduled by the announcing UE (e.g., when the second UE 504 is the third UE 506). In some aspects, for each neighbour UE, the beam-based FD opportunity announcement may indicate one or more transmission beams allowed to overlap with the reservation at least in time. A transmission beam may be identified by TCI state ID or reference signal ID from either neighbour UE or the announcing UE.

For example, in some aspects, the beam-based FD opportunity announcement may indicate an allowed transmission beam-based on the beam-based FD opportunity announcement including at least one of a TCI state ID or a reference signal ID. The at least one of the TCI state ID or the reference signal ID may be associated with the first UE 502 or the third UE 506. For example, the beam-based FD opportunity announcement may indicate that the third UE 506 may use transmission beam 512 to transmit to the first UE, which may receive using a reception beam 514. In some aspects, the transmission beam 512 and/or the reception beam 514 may be selected based on a determination that self-interference between reception beam 514 and the transmission beam 516 is unlikely to exceed an interference threshold. In some cases, in addition to the self-interference at the first UE 502, the transmission beam 512 and/or the reception beam 514 may be selected based on a determination that a signal-to-interference-plus-noise-ratio (SINR) at the first UE 502 corresponding to the beams 512 and 514 and an SINR at the second UE 504 corresponding to the beams 516 and 518 exceed an SINR threshold. In some aspects, the beam-based FD opportunity announcement may include a transmission parameter indication that indicates, in association with at least one of the allowed transmission beam or a group of allowed transmission beams, at least one transmission parameter associated with the second transmission. The at least one transmission parameter may include at least one of an allowed transmission parameter associated with the second transmission or a disallowed parameter associated with the second transmission. In some aspects, the at least one transmission parameter may include at least one of a transmission power, a transmission timing, a modulation and coding scheme (MCS), a transmission rank, a precoding matrix, or a target reference signal received power (RSRP). In some aspects, the at least one transmission parameter may include at least one of an associated time range or an associated frequency range of transmission. For example, the associated frequency range may include at least one of a subband, a guard band, or a frequency range associated with a frequency range corresponding to the first transmission.

In some aspects, the at least one transmission parameter may be associated with at least one reservation of sidelink transmission resources, including a reservation of the first set of sidelink resources, that satisfies an association condition. For example, in some aspects, the at least one reservation may satisfy the association condition based on the beam-based FD opportunity announcement being indicated in the SCI that reserves the first transmission. In some aspects, the at least one reservation may satisfy the association condition based on the at least one reservation being associated with a specified resource window. The specified resource window may include at least one of a time resource window or a frequency resource window. The at least one of the time resource window or the frequency resource window may be defined in relation to at least one of a time resource or a frequency resource used for transmitting the beam-based FD opportunity announcement. For example, the time and/or frequency resource window may be indicated by the first UE 502 or determined by a rule such as a rule that indicates that the time and/or frequency window has a start time X ms after the beam-based FD opportunity announcement is transmitted and/or received, where X>=0. In some aspects, the first UE 502 may also transmit an indication of the specified resource window. In some aspects, the at least one transmission parameter may be associated with at least one of a bandwidth part or a component carrier (in implementations involving sidelink carrier aggregation).

As shown by reference number 520, the third UE 506 may transmit, and the first UE 502 may receive, an acceptance announcement. The acceptance announcement may be associated with the beam-based FD opportunity announcement. In some aspects, the first UE 502 may receive the acceptance announcement based on receiving an acceptance communication including the acceptance announcement. The acceptance communication may include at least one of SCI, a MAC CE, or an RRC message. In some aspects, the acceptance announcement may indicate a set of transmission parameters associated with the second transmission. In some aspects, the indicated transmission parameters in the acceptance announcement may overlap at least partially in time with the first set of resources reserved by the first SCI 508. In some aspects, the third UE 506 may transmit, and/or the first UE 502 may receive the acceptance announcement based on a transmission priority associated with the third UE satisfying a priority threshold. In some aspects, the third UE 506 may transmit, and/or the first UE 502 may receive the acceptance announcement based on a channel measurement associated with the third UE 506 satisfying a channel measurement threshold. The channel measurement may include at least one of a channel busy ratio (CBR) or a channel occupancy ratio (COR). In some aspects, the third UE 506 may transmit, and/or the first UE 502 may receive the acceptance announcement based on a failure to detect an additional conflicted beam-based FD opportunity announcement and an additional resource reservation for sidelink resources indicated in the acceptance announcement. For example, the third UE 506 may transmit, and/or the first UE 502 may receive the acceptance announcement based on there being no beam-based FD opportunity announced by other announcing UE(s) for the same transmission resource but with conflicting allowed transmission parameters, and/or based on there being no legacy reservation without an FD announcement for the same transmission resource. For example, if the first UE 502 announces that the third UE 506 can only use its transmission beam #1 in slot #1 to communicate with the first UE 502, while the second UE 504 announces that the third UE 506 can only use its transmission beam #5 in slot #1 to communicate with the second UE 504, the third UE 506 may not transmit in slot #1 due to the conflicted allowed transmission beams. In some other aspects, the third UE 506 may transmit, and/or the first UE 502 may receive the acceptance announcement even if there are multiple beam-based FD opportunity announcements for the same resources by different UEs with conflicting allowed transmission parameters, as long as any announcement does not indicate an incompatibility with the third UE 506 choosing some another FD opportunity. For example, if the first UE 502 announces that the third UE 506 can use its transmission beam #1 in slot #1 to communicate with the first UE 502, while the second UE 504 announces that the third UE 506 can use its transmission beam #5 in slot #1 to communicate with the second UE 504, then neither the first UE 502 nor the second UE 504 has indicated a compatibility issue with the third UE 506's choice. In this case, the third UE 506 may choose to transmit using beam #1 in slot #1 to communicate with the first UE 502. In such cases, the second UE 504 may simply not utilize its FD opportunity for reception. In some aspects, as shown by reference number 522, the first UE 502 may send an FD confirmation to the third UE 506 after receiving the acceptance announcement 520. The FD confirmation may enable the first UE 502 to down select one or more UE(s) if the first UE 502 receives an acceptance announcement 520 from multiple UEs. In some aspects, the third UE 506 may not send the acceptance announcement 520, but may directly send the second transmission 526 under similar conditions as for sending the acceptance announcement 520.

As shown by reference number 524, the UE 502 may transmit the first transmission and, as shown by reference number 526, the third UE 506 may transmit, and the first UE 502 may receive, a second transmission. The first UE 502 may receive the second transmission from the third UE 506 on a first reception beam 514 in a first sidelink resource and may transmit, in full-duplex communication, to the second UE 504 with the first transmission beam 516 in a second sidelink resource, of a set of sidelink resources, that is at least partially overlapping in time with the first sidelink resource, in association with the first reception beam 512 and the first transmission beam 516 being compatible for FD communication. In some aspects, the first reception beam 514 may be compatible with the first transmission beam 516 based on satisfaction of a sidelink self-interference condition, as described further in connection with FIGS. 6A and 6B. In some aspects, the first reception beam 514 may be compatible with the first transmission beam 516 based on the first transmission beam failing to be indicated by a forbidden transmission indicator. In some aspects, the forbidden transmission indicator may correspond to at least one of the first transmission or an additional transmission. In some aspects, the forbidden transmission indicator may include a binary indicator or an indication of at least one forbidden transmission condition. In some aspects, the second UE 504 may sense a reservation of the second sidelink resource during a sensing phase. For example, the simultaneous transmission and reception with the compatible beams 514 and 516 may be allowed even though the second reservation is sensed by the transmission beam 512 during a sensing phase.

As indicated above, FIG. 5 is provided as an example. Other examples may differ from what is described with regard to FIG. 5.

FIGS. 6A and 6B are diagrams illustrating examples 600 and 622, respectively, associated with autonomous determination of sidelink FD via beam-based sensing, in accordance with the present disclosure. As shown, a UE1 602 may communicate with an FD UE2 604, which may communicate with a UE3 606. The UE1 602, FD UE2 604, and UE3 606 may communicate over a sidelink network (e.g., as described above in connection with FIG. 4). In some aspects, the UEs 602, 604, and 606 may be, be similar to, include, or be included in one or more of the UEs 502, 504, and/or 506 depicted in FIG. 5, the UEs 405-1 and/or 405-2 depicted in FIG. 4, and/or the UE 120 depicted in FIGS. 1-3.

As shown by reference number 608, the UE1 602 may transmit SCI. As shown by reference number 610, the FD UE2 604 may receive the SCI and, as shown by reference number 612, the FD UE2 604 also may sense the SCI. The SCI may be received by the FD UE2 604 via a beam 614 and by the FD UE2 604 via a sensing beam 616. In some cases, in beam-based transmission and reception in sidelink mode 2, based on the UE2 604 sensing the SCI and corresponding reservation (e.g., indicated in the SCI) via the sensing beam 616, the UE2 604 may not use the sensing beam 616 for a transmission using resources 618 overlapped with the reservation of resources 620 in time and/or frequency. In some cases, this can happen even if the reception via the beam 614 at the FD UE2 604 faces only insignificant self-interference 622 if the UE2 604 were to transmit using the sensing beam 616 using resources 618 that are overlapping with UE1's transmission resources 620 and which will not affect the reception of UE1's transmission 608 at the FD UE2 604 via the reception beam 614.

However, in some aspects, as described above in connection with FIG. 5, an FD capable UE (e.g., UE2 604) may transmit a transmission overlapping in time and/or frequency with the reception of the communication reserved by the SCI if the corresponding beams 614 and 616 are compatible. As shown in the example 624 of FIG. 6B, for example, the UE1 602 may transmit a PSSCH transmission 626 to the FD UE2 604, which may receive the PSSCH transmission 626 via the beam 614. The FD UE2 604 may transmit, using the beam 616, a PSSCH transmission 628 to the UE3 606 using sidelink resources 618 that at least partially overlap the sidelink resources 620 associated with the PSSCH transmission 626 based on the beam 614 and the beam 616 being a compatible beam pair.

In some aspects, the beams 614 and 616 may be a compatible beam pair based on the beam 616 being determined to be likely to cause negligible SI to the beam 614 under one or more constraints. For example, in some aspects, the beams 614 and 616 may be a compatible beam pair based on a determination that a resulting SI may satisfy an SI threshold (e.g., SI<SI threshold) under a power constraint (e.g., Tx power<power limit). In some aspects, the FD UE2 604 may determine compatible beam pairs via a dedicated reference signal and/or data traffic. In some aspects, the beams 614 and 616 may be a compatible beam pair even if the reservation of the PSSCH transmission 624 is sensed by the beam 616 during a sensing phase.

In some aspects, to protect critical receptions, a forbidden transmission indicator may be used to forbid the transmission 618 that at least overlaps in time with a particular reservation reception (e.g., the reception of the PSSCH transmission 624), even if the beams 614 and 616 are compatible beams. In some aspects, for example, the forbidden transmission indicator may be used because the SI may not be well-predicted (e.g., the SI may be due to a sudden presence of a strong reflector). In some aspects, the forbidden transmission indicator may be signalled by the UE1 602 for each reservation or each group of reservations (e.g., in the SCI), or determined by the FD UE2 604, based on a rule provided by a wireless communication standard and/or another network node (e.g., a base station). In some aspects, the forbidden transmission indicator may include a binary indication and/or a set of conditions under which FD is forbidden. In some aspects, FD may be forbidden (and indicated as such by the forbidden transmission indicator) based on a priority associated with the reception reservation satisfying a threshold (e.g., exceeding the threshold), a priority associated with the transmission satisfying a threshold (e.g., being lower than a threshold), an estimated SI satisfying (e.g., exceeding) a threshold, an estimated SINR satisfying (e.g., being less than) a threshold, an estimated RSRP satisfying (e.g., being less than) a threshold, a measured CBR satisfying (e.g., being less than) a threshold, a measured CR satisfying (e.g., being less than) a threshold, and/or a guard band satisfying (e.g., being less than) a threshold, among other examples.

As indicated above, FIGS. 6A and 6B are provided as examples. Other examples may differ from what is described with regard to FIGS. 6A and 6B.

FIG. 7 is a diagram illustrating an example process 700 performed, for example, by a first UE, in accordance with the present disclosure. Example process 700 is an example where the first UE (e.g., UE 502) performs operations associated with beam-based FD opportunity announcements.

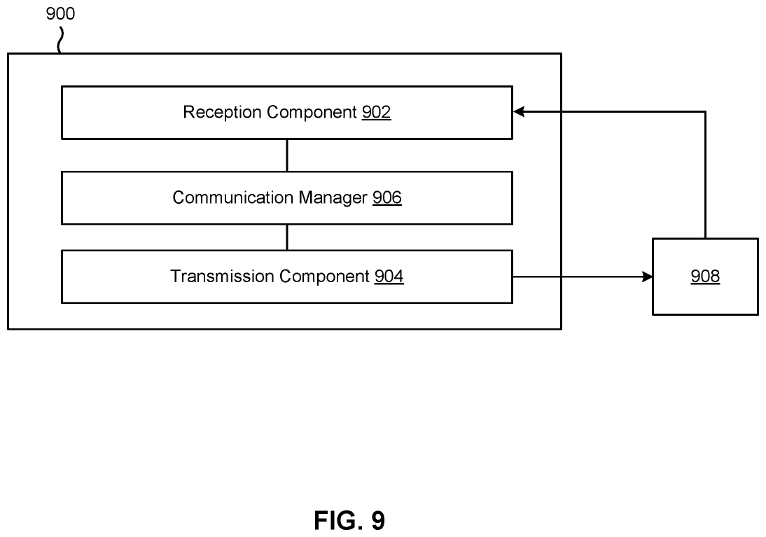

As shown in FIG. 7, in some aspects, process 700 may include reserving a first set of sidelink resources for a first transmission to a second UE (block 710). For example, the first UE (e.g., using communication manager 906, depicted in FIG. 9) may reserve a first set of sidelink resources for a first transmission to a second UE, as described above.

As further shown in FIG. 7, in some aspects, process 700 may include transmitting a beam-based FD opportunity announcement associated with a second transmission that at least partially overlaps the first transmission in time, the beam-based FD opportunity announcement indicating a first transmission beam associated with the third UE (block 720). For example, the first UE (e.g., using transmission component 904 and/or communication manager 906, depicted in FIG. 9) may transmit a beam-based FD opportunity announcement associated with a second transmission that at least partially overlaps the first transmission in time, the beam-based FD opportunity announcement indicating a first transmission beam associated with the third UE, as described above.

Process 700 may include additional aspects, such as any single aspect or any combination of aspects described below and/or in connection with one or more other processes described elsewhere herein.

In a first aspect, transmitting the beam-based FD opportunity announcement comprises transmitting first SCI that includes the beam-based FD opportunity announcement. In a second aspect, alone or in combination with the first aspect, reserving the first set of sidelink resources comprises transmitting first SCI that includes a reservation of the first set of sidelink resources, and wherein transmitting the beam-based FD opportunity announcement comprises transmitting second SCI that includes the beam-based FD opportunity announcement. In a third aspect, alone or in combination with one or more of the first and second aspects, the beam-based FD opportunity announcement indicates the third UE. In a fourth aspect, alone or in combination with one or more of the first through third aspects, the beam-based FD opportunity announcement indicates the third UE based on the beam-based FD opportunity announcement including a UE ID associated with the third UE. In a fifth aspect, alone or in combination with one or more of the first through fourth aspects, the beam-based FD opportunity announcement indicates the third UE based on a destination ID associated with the first transmission, the destination ID comprising a UE ID of the second UE, wherein a UE ID of the third UE is the same as the UE ID of the second UE.

In a sixth aspect, alone or in combination with one or more of the first through fifth aspects, the beam-based FD opportunity announcement indicates the allowed transmission beam-based on the beam-based FD opportunity announcement including at least one of a TCI state ID or a reference signal ID. In a seventh aspect, alone or in combination with one or more of the first through sixth aspects, the TCI state ID or the reference signal ID is associated with the first UE or the third UE. In an eighth aspect, alone or in combination with one or more of the first through seventh aspects, the beam-based FD opportunity announcement comprises a transmission parameter indication that indicates, in association with at least one of the allowed transmission beam or a group of allowed transmission beams, at least one transmission parameter associated with the second transmission. In a ninth aspect, alone or in combination with one or more of the first through eighth aspects, the at least one transmission parameter comprises at least one of an allowed transmission parameter associated with the second transmission or a disallowed parameter associated with the second transmission.

In a tenth aspect, alone or in combination with one or more of the first through ninth aspects, the at least one transmission parameter comprises at least one of a transmission power, a transmission timing, an MCS, a transmission rank, a precoding matrix, or a target RSRP. In an eleventh aspect, alone or in combination with one or more of the first through tenth aspects, the at least one transmission parameter comprises at least one of an associated time range or an associated frequency range. In a twelfth aspect, alone or in combination with one or more of the first through eleventh aspects, the associated frequency range comprises at least one of a subband, a guard band, or a frequency range associated with a frequency range corresponding to the first transmission.

In a thirteenth aspect, alone or in combination with one or more of the first through twelfth aspects, the at least one transmission parameter is associated with at least one reservation of sidelink transmission resources, including a reservation of the first set of sidelink resources, that satisfies an association condition. In a fourteenth aspect, alone or in combination with one or more of the first through thirteenth aspects, reserving the first set of sidelink resources comprises transmitting SCI that includes a reservation of the first set of sidelink resources, and wherein the at least one reservation satisfies the association condition based on the beam-based FD opportunity announcement being indicated in the SCI. In a fifteenth aspect, alone or in combination with one or more of the first through fourteenth aspects, the at least one reservation satisfies the association condition based on the at least one reservation being associated with a specified resource window. In a sixteenth aspect, alone or in combination with one or more of the first through fifteenth aspects, the specified resource window comprises at least one of a time resource window or a frequency resource window, wherein the at least one of the time resource window or the frequency resource window is defined in relation to at least one of a time resource or a frequency resource used for transmitting the beam-based FD opportunity announcement. In a seventeenth aspect, alone or in combination with one or more of the first through sixteenth aspects, process 700 includes transmitting an indication of the specified resource window. In an eighteenth aspect, alone or in combination with one or more of the first through seventeenth aspects, the at least one transmission parameter is associated with at least one of a bandwidth part or a component carrier.

In a nineteenth aspect, alone or in combination with one or more of the first through eighteenth aspects, transmitting the beam-based FD opportunity announcement comprises transmitting the beam-based FD opportunity announcement via at least one of an SCI part 1, an SCI part 2, a MAC CE, or an RRC message. In a twentieth aspect, alone or in combination with one or more of the first through nineteenth aspects, process 700 includes receiving, from the third UE, an acceptance announcement associated with the beam-based FD opportunity announcement. In a twenty-first aspect, alone or in combination with one or more of the first through twentieth aspects, the acceptance announcement indicates a set of transmission parameters associated with the second transmission. In a twenty-second aspect, alone or in combination with one or more of the first through twenty-first aspects, receiving the acceptance announcement comprises receiving the acceptance announcement based on a transmission priority associated with the third UE satisfying a priority threshold. In a twenty-third aspect, alone or in combination with one or more of the first through twenty-second aspects, receiving the acceptance announcement comprises receiving the acceptance announcement based on a channel measurement associated with the third UE satisfying a channel measurement threshold. In a twenty-fourth aspect, alone or in combination with one or more of the first through twenty-third aspects, the channel measurement comprises at least one of a CBR or a COR.

In a twenty-fifth aspect, alone or in combination with one or more of the first through twenty-fourth aspects, receiving the acceptance announcement comprises receiving the acceptance announcement based on a failure to detect an additional conflicted beam-based FD opportunity announcement and an additional resource reservation for sidelink resources indicated in the acceptance announcement. In a twenty-sixth aspect, alone or in combination with one or more of the first through twenty-fifth aspects, receiving the acceptance announcement comprises receiving an acceptance communication including the acceptance announcement. In a twenty-seventh aspect, alone or in combination with one or more of the first through twenty-sixth aspects, the acceptance communication comprises at least one of SCI, a MAC CE, or an RRC message.

In a twenty-eighth aspect, alone or in combination with one or more of the first through twenty-seventh aspects, process 700 includes receiving the second transmission from the third UE on a first reception beam in a first sidelink resource, and transmitting, in full-duplex communication, to the second UE with the first transmission beam in a second sidelink resource, of the first set of sidelink resources, that is at least partially overlapping in time with the first sidelink resource, in association with the first reception beam and the first transmission beam being compatible for full-duplex communication. In a twenty-ninth aspect, alone or in combination with one or more of the first through twenty-eighth aspects, the first reception beam is compatible with the first transmission beam-based on satisfaction of a sidelink self-interference condition. In a thirtieth aspect, alone or in combination with one or more of the first through twenty-ninth aspects, the first reception beam is compatible with the first transmission beam-based on the first transmission beam failing to be indicated by a forbidden transmission indicator. In a thirty-first aspect, alone or in combination with one or more of the first through thirtieth aspects, the forbidden transmission indicator corresponds at least one of the first transmission or an additional transmission. In a thirty-second aspect, alone or in combination with one or more of the first through thirty-first aspects, the forbidden transmission indicator comprises a binary indicator or an indication of at least one forbidden transmission condition.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

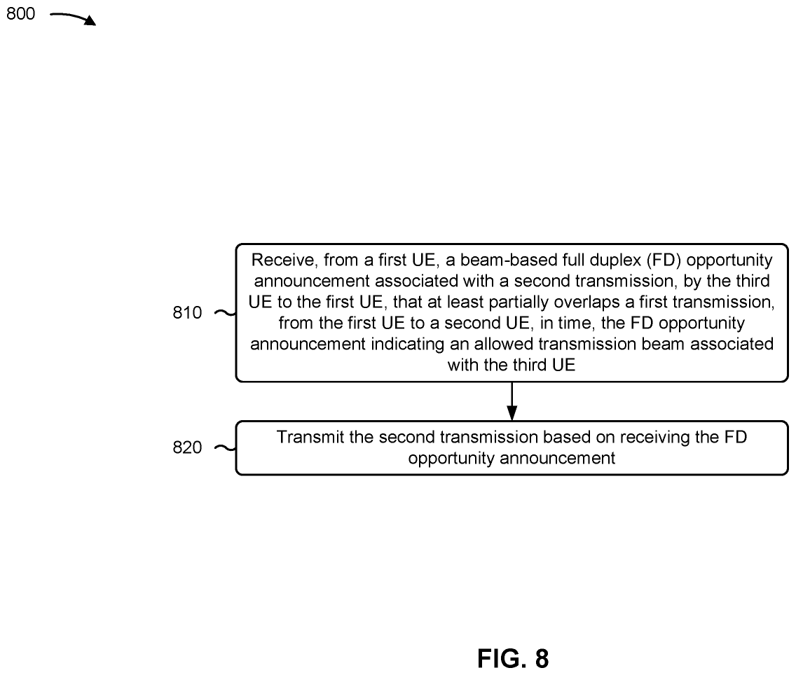

FIG. 8 is a diagram illustrating an example process 800 performed, for example, by a third UE, in accordance with the present disclosure. Example process 800 is an example where the third UE (e.g., UE 506) performs operations associated with beam-based full duplex opportunity announcements.

As shown in FIG. 8, in some aspects, process 800 may include receiving, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE (block 810). For example, the third UE (e.g., using reception component 902 and/or communication manager 906, depicted in FIG. 9) may receive, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE, as described above.

As further shown in FIG. 8, in some aspects, process 800 may include transmitting the second transmission based on receiving the beam-based FD opportunity announcement (block 820). For example, the third UE (e.g., using transmission component 904 and/or communication manager 906, depicted in FIG. 9) may transmit the second transmission based on receiving the beam-based FD opportunity announcement, as described above.

Process 800 may include additional aspects, such as any single aspect or any combination of aspects described below and/or in connection with one or more other processes described elsewhere herein.

In a first aspect, receiving the beam-based FD opportunity announcement comprises receiving first SCI that includes the beam-based FD opportunity announcement. In a second aspect, alone or in combination with the first aspect, process 800 includes receiving first SCI including a reservation of a first set of sidelink resources associated with the first transmission, and wherein receiving the beam-based FD opportunity announcement comprises receiving second SCI that includes the beam-based FD opportunity announcement. In a third aspect, alone or in combination with one or more of the first and second aspects, the beam-based FD opportunity announcement indicates the third UE. In a fourth aspect, alone or in combination with one or more of the first through third aspects, the beam-based FD opportunity announcement indicates the third UE based on the beam-based FD opportunity announcement including a UE ID associated with the third UE. In a fifth aspect, alone or in combination with one or more of the first through fourth aspects, the beam-based FD opportunity announcement indicates the third UE based on a destination ID associated with the first transmission, the destination ID comprising a UE ID of the second UE, wherein a UE ID of the third UE is the same as the UE ID of the second UE. In a sixth aspect, alone or in combination with one or more of the first through fifth aspects, the beam-based FD opportunity announcement indicates the allowed transmission beam-based on the beam-based FD opportunity announcement including at least one of a TCI state ID or a reference signal ID. In a seventh aspect, alone or in combination with one or more of the first through sixth aspects, the TCI state ID or the reference signal ID is associated with the first UE or the third UE.

In an eighth aspect, alone or in combination with one or more of the first through seventh aspects, the beam-based FD opportunity announcement comprises a transmission parameter indication that indicates, in association with at least one of the allowed transmission beam or a group of allowed transmission beams, at least one transmission parameter associated with the second transmission. In a ninth aspect, alone or in combination with one or more of the first through eighth aspects, the at least one transmission parameter comprises at least one of an allowed transmission parameter associated with the second transmission or a disallowed parameter associated with the second transmission. In a tenth aspect, alone or in combination with one or more of the first through ninth aspects, the at least one transmission parameter comprises at least one of a transmission power, a transmission timing, an MCS, a transmission rank, a precoding matrix, or a target RSRP. In an eleventh aspect, alone or in combination with one or more of the first through tenth aspects, the at least one transmission parameter comprises at least one of an associated time range or an associated frequency range. In a twelfth aspect, alone or in combination with one or more of the first through eleventh aspects, the associated frequency range comprises at least one of a subband, a guard band, or a frequency range associated with a frequency range corresponding to the first transmission. In a thirteenth aspect, alone or in combination with one or more of the first through twelfth aspects, the at least one transmission parameter is associated with at least one reservation of sidelink transmission resources, including a reservation of the first set of sidelink resources, that satisfies an association condition. In a fourteenth aspect, alone or in combination with one or more of the first through thirteenth aspects, process 800 includes receiving SCI including a reservation of a first set of sidelink resources associated with the first transmission, and wherein the at least one reservation satisfies the association condition based on the beam-based FD opportunity announcement being indicated in the SCI. In a fifteenth aspect, alone or in combination with one or more of the first through fourteenth aspects, the at least one reservation satisfies the association condition based on the at least one reservation being associated with a specified resource window. In a sixteenth aspect, alone or in combination with one or more of the first through fifteenth aspects, the specified resource window comprises at least one of a time resource window or a frequency resource window, wherein the at least one of the time resource window or the frequency resource window is defined in relation to at least one of a time resource or a frequency resource used for transmitting the beam-based full duplex opportunity announcement. In a seventeenth aspect, alone or in combination with one or more of the first through sixteenth aspects, process 800 includes receiving an indication of the specified resource window. In an eighteenth aspect, alone or in combination with one or more of the first through seventeenth aspects, the at least one transmission parameter is associated with at least one of a bandwidth part or a component carrier. In a nineteenth aspect, alone or in combination with one or more of the first through eighteenth aspects, receiving the beam-based FD opportunity announcement comprises receiving the beam-based FD opportunity announcement via at least one of an SCI part 1, an SCI part 2, a MAC CE, or an RRC message.

In a twentieth aspect, alone or in combination with one or more of the first through nineteenth aspects, process 800 includes transmitting, to the first UE, an acceptance announcement associated with the beam-based FD opportunity announcement. In a twenty-first aspect, alone or in combination with one or more of the first through twentieth aspects, the acceptance announcement indicates a set of transmission parameters associated with the second transmission. In a twenty-second aspect, alone or in combination with one or more of the first through twenty-first aspects, transmitting the acceptance announcement comprises transmitting the acceptance announcement based on a transmission priority associated with the third UE satisfying a priority threshold. In a twenty-third aspect, alone or in combination with one or more of the first through twenty-second aspects, transmitting the acceptance announcement comprises transmitting the acceptance announcement based on a channel measurement associated with the third UE satisfying a channel measurement threshold. In a twenty-fourth aspect, alone or in combination with one or more of the first through twenty-third aspects, the channel measurement comprises at least one of a CBR or a COR. In a twenty-fifth aspect, alone or in combination with one or more of the first through twenty-fourth aspects, transmitting the acceptance announcement comprises transmitting the acceptance announcement based on a failure to detect an additional conflicted beam-based FD opportunity announcement and an additional resource reservation for sidelink resources indicated in the acceptance announcement.

In a twenty-sixth aspect, alone or in combination with one or more of the first through twenty-fifth aspects, transmitting the acceptance announcement comprises transmitting an acceptance communication including the acceptance announcement. In a twenty-seventh aspect, alone or in combination with one or more of the first through twenty-sixth aspects, the acceptance communication comprises at least one of SCI, a MAC CE, or an RRC message. In a twenty-eighth aspect, alone or in combination with one or more of the first through twenty-seventh aspects, process 800 includes transmitting the second transmission to the first UE in association with a first reception beam in a first sidelink resource, and receiving, in full-duplex communication, from the first UE in association with the first transmission beam in a second sidelink resource that is at least partially overlapping in time with the first sidelink resource, in association with the first reception beam and the first transmission beam being compatible for full-duplex communication. In a twenty-ninth aspect, alone or in combination with one or more of the first through twenty-eighth aspects, the first reception beam is compatible with the first transmission beam-based on satisfaction of a sidelink self-interference condition. In a thirtieth aspect, alone or in combination with one or more of the first through twenty-ninth aspects, the first reception beam is compatible with the first transmission beam-based on the first transmission beam failing to be indicated by a forbidden transmission indicator. In a thirty-first aspect, alone or in combination with one or more of the first through thirtieth aspects, the forbidden transmission indicator corresponds to at least one of the first transmission or an additional transmission. In a thirty-second aspect, alone or in combination with one or more of the first through thirty-first aspects, the forbidden transmission indicator comprises a binary indicator or an indication of at least one forbidden transmission condition. In a thirty-third aspect, alone or in combination with one or more of the first through thirty-second aspects, process 800 includes sensing a reservation of the second sidelink resource during a sensing phase.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5-6B. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may reserve a first set of sidelink resources for a first transmission to a second UE. The transmission component 904 may transmit a beam-based FD opportunity announcement associated with a second transmission that at least partially overlaps the first transmission in time, the beam-based FD opportunity announcement indicating a first transmission beam associated with the third UE. The transmission component 904 may transmit an indication of the specified resource window. The reception component 902 may receive, from the third UE, an acceptance announcement associated with the beam-based FD opportunity announcement. The reception component 902 may receive the second transmission from the third UE on a first reception beam in a first sidelink resource. The transmission component 904 may transmit, in full-duplex communication, to the second UE with the first transmission beam in a second sidelink resource, of the first set of sidelink resources, that is at least partially overlapping in time with the first sidelink resource, in association with the first reception beam and the first transmission beam being compatible for full-duplex communication.

The reception component 902 may receive, from a first UE, a beam-based FD opportunity announcement associated with a second transmission, by the third UE to the first UE, that at least partially overlaps a first transmission, from the first UE to a second UE, in time, the beam-based FD opportunity announcement indicating an allowed transmission beam associated with the third UE. The transmission component 904 may transmit the second transmission based on receiving the beam-based FD opportunity announcement. The reception component 902 may receive first SCI including a reservation of a first set of sidelink resources associated with the first transmission, and wherein receiving the beam-based FD opportunity announcement comprises receiving second SCI that includes the beam-based FD opportunity announcement. The reception component 902 may receive SCI including a reservation of a first set of sidelink resources associated with the first transmission, and wherein the at least one reservation satisfies the association condition based on the beam-based FD opportunity announcement being indicated in the SCI. The reception component 902 may receive an indication of the specified resource window. The transmission component 904 may transmit, to the first UE, an acceptance announcement associated with the beam-based FD opportunity announcement. The transmission component 904 may transmit the second transmission to the first UE in association with a first reception beam in a first sidelink resource. The reception component 902 may receive, in full-duplex communication, from the first UE in association with the first transmission beam in a second sidelink resource that is at least partially overlapping in time with the first sidelink resource, in association with the first reception beam and the first transmission beam being compatible for full-duplex communication. The communication manager 906 may sense a reservation of the second sidelink resource during a sensing phase.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a first user equipment (UE), comprising: reserving a first set of sidelink resources for a first transmission to a second UE; and transmitting a beam-based full duplex (FD) opportunity announcement associated with a second transmission, by a third UE to the first UE, that at least partially overlaps the first transmission in time, the beam-based FD opportunity announcement indicating a first transmission beam associated with the third UE.
Aspect 2: The method of Aspect 1, wherein transmitting the beam-based FD opportunity announcement comprises transmitting first sidelink control information (SCI) that includes the beam-based FD opportunity announcement.
Aspect 3: The method of any of Aspects 1-2, wherein reserving the first set of sidelink resources comprises transmitting first sidelink control information (SCI) that includes a reservation of the first set of sidelink resources, and wherein transmitting the beam-based FD opportunity announcement comprises transmitting second SCI that includes the beam-based FD opportunity announcement.
Aspect 4: The method of any of Aspects 1-3, wherein the beam-based FD opportunity announcement indicates the third UE.
Aspect 5: The method of Aspect 4, wherein the beam-based FD opportunity announcement indicates the third UE based on the beam-based FD opportunity announcement including a UE identifier (ID) associated with the third UE.
Aspect 6: The method of either of claim 4 or 5, wherein the beam-based FD opportunity announcement indicates the third UE based on a destination identifier (ID) associated with the first transmission, the destination ID comprising a UE ID of the second UE, wherein a UE ID of the third UE is the same as the UE ID of the second UE.
Aspect 7: The method of any of Aspects 1-6, wherein the beam-based FD opportunity announcement indicates the allowed transmission beam-based on the beam-based FD opportunity announcement including at least one of a transmission configuration indicator (TCI) state identifier (ID) or a reference signal ID.
Aspect 8: The method of Aspect 7, wherein the TCI state ID or the reference signal ID is associated with the first UE or the third UE.
Aspect 9: The method of any of Aspects 1-8, wherein the beam-based FD opportunity announcement comprises a transmission parameter indication that indicates, in association with at least one of the allowed transmission beam or a group of allowed transmission beams, at least one transmission parameter associated with the second transmission.
Aspect 10: The method of Aspect 9, wherein the at least one transmission parameter comprises at least one of an allowed transmission parameter associated with the second transmission or a disallowed parameter associated with the second transmission.
Aspect 11: The method of either of claim 9 or 10, wherein the at least one transmission parameter comprises at least one of a transmission power, a transmission timing, a modulation and coding scheme, a transmission rank, a precoding matrix, or a target reference signal received power.
Aspect 12: The method of any of Aspects 9-11, wherein the at least one transmission parameter comprises at least one of an associated time range or an associated frequency range.
Aspect 13: The method of Aspect 12, wherein the associated frequency range comprises at least one of a subband, a guard band, or a frequency range associated with a frequency range corresponding to the first transmission.
Aspect 14: The method of any of Aspects 9-13, wherein the at least one transmission parameter is associated with at least one reservation of sidelink transmission resources, including a reservation of the first set of sidelink resources, that satisfies an association condition.
Aspect 15: The method of Aspect 14, wherein reserving the first set of sidelink resources comprises transmitting sidelink control information (SCI) that includes a reservation of the first set of sidelink resources, and wherein the at least one reservation satisfies the association condition based on the beam-based FD opportunity announcement being indicated in the SCI.
Aspect 16: The method of either of claim 14 or 15, wherein the at least one reservation satisfies the association condition based on the at least one reservation being associated with a specified resource window.
Aspect 17: The method of any of Aspects 14-16, wherein the specified resource window comprises at least one of a time resource window or a frequency resource window, wherein the at least one of the time resource window or the frequency resource window is defined in relation to at least one of a time resource or a frequency resource used for transmitting the beam-based full duplex opportunity announcement.
Aspect 18: The method of Aspect 17, further comprising transmitting an indication of the specified resource window.
Aspect 19: The method of any of Aspects 9-18, wherein the at least one transmission parameter is associated with at least one of a bandwidth part or a component carrier.
Aspect 20: The method of any of Aspects 1-19, wherein transmitting the beam-based FD opportunity announcement comprises transmitting the beam-based FD opportunity announcement via at least one of a sidelink control information (SCI) part 1, an SCI part 2, a medium access control (MAC) control element (MAC CE), or a radio resource control message.
Aspect 21: The method of any of Aspects 1-20, further comprising receiving, from the third UE, an acceptance announcement associated with the beam-based FD opportunity announcement.
Aspect 22: The method of Aspect 21, wherein the acceptance announcement indicates a set of transmission parameters associated with the second transmission.
Aspect 23: The method of either of claim 21 or 22, wherein receiving the acceptance announcement comprises receiving the acceptance announcement based on a transmission priority associated with the third UE satisfying a priority threshold.
Aspect 24: The method of any of Aspects 21-23, wherein receiving the acceptance announcement comprises receiving the acceptance announcement based on a channel measurement associated with the third UE satisfying a channel measurement threshold.
Aspect 25: The method of Aspect 24, wherein the channel measurement comprises at least one of a channel busy ratio or a channel occupancy ratio.
Aspect 26: The method of any of Aspects 21-25, wherein receiving the acceptance announcement comprises receiving the acceptance announcement based on a failure to detect an additional conflicted beam-based FD opportunity announcement and an additional resource reservation for sidelink resources indicated in the acceptance announcement.
Aspect 27: The method of any of Aspects 21-26, wherein receiving the acceptance announcement comprises receiving an acceptance communication including the acceptance announcement.
Aspect 28: The method of Aspect 27, wherein the acceptance communication comprises at least one of sidelink control information, a medium access control (MAC) control element (MAC CE), or a radio resource control message.
Aspect 29: The method of any of Aspects 1-28, further comprising: receiving the second transmission from the third UE on a first reception beam in a first sidelink resource; and transmitting, in full-duplex communication, to the second UE with the first transmission beam in a second sidelink resource, of the first set of sidelink resources, that is at least partially overlapping in time with the first sidelink resource, in association with the first reception beam and the first transmission beam being compatible for full-duplex communication.
Aspect 30: The method of Aspect 29, wherein the first reception beam is compatible with the first transmission beam-based on satisfaction of a sidelink self-interference condition.
Aspect 31: The method of either of claim 29 or 30, wherein the first reception beam is compatible with the first transmission beam-based on the first transmission beam failing to be indicated by a forbidden transmission indicator.
Aspect 32: The method of Aspect 31, wherein the forbidden transmission indicator corresponds at least one of the first transmission or an additional transmission.
Aspect 33: The method of either of Aspects 31 or 32, wherein the forbidden transmission indicator comprises a binary indicator or an indication of at least one forbidden transmission condition.
Aspect 34: A method of wireless communication performed by third user equipment (UE), comprising: receiving, from a first UE, a beam-based full duplex (FD) opportunity announcement associated with a second transmission, by the third UE to the first UE, that at least partially overlaps a first transmission, from the first UE to a second UE, in time, the beam-based FD opportunity announcement indicating an allowed transmission beam associated with the third UE; and transmitting the second transmission based on receiving the beam-based FD opportunity announcement.
Aspect 35: The method of Aspect 34, wherein receiving the beam-based FD opportunity announcement comprises receiving first sidelink control information (SCI) that includes the beam-based FD opportunity announcement.
Aspect 36: The method of either of claim 34 or 35, further comprising receiving first sidelink control information (SCI) including a reservation of a first set of sidelink resources associated with the first transmission, and wherein receiving the beam-based FD opportunity announcement comprises receiving second SCI that includes the beam-based FD opportunity announcement.
Aspect 37: The method of any of Aspects 34-36, wherein the beam-based FD opportunity announcement indicates the third UE.
Aspect 38: The method of Aspect 37, wherein the beam-based FD opportunity announcement indicates the third UE based on the beam-based FD opportunity announcement including a UE identifier (ID) associated with the third UE.
Aspect 39: The method of either of claim 37 or 38, wherein the beam-based FD opportunity announcement indicates the third UE based on a destination identifier (ID) associated with the first transmission, the destination ID comprising a UE ID of the second UE, wherein a UE ID of the third UE is the same as the UE ID of the second UE.
Aspect 40: The method of any of Aspects 34-39, wherein the beam-based FD opportunity announcement indicates the allowed transmission beam-based on the beam-based FD opportunity announcement including at least one of a transmission configuration indicator (TCI) state identifier (ID) or a reference signal ID.
Aspect 41: The method of Aspect 40, wherein the TCI state ID or the reference signal ID is associated with the first UE or the third UE.
Aspect 42: The method of any of Aspects 34-41, wherein the beam-based FD opportunity announcement comprises a transmission parameter indication that indicates, in association with at least one of the allowed transmission beam or a group of allowed transmission beams, at least one transmission parameter associated with the second transmission.
Aspect 43: The method of Aspect 42, wherein the at least one transmission parameter comprises at least one of an allowed transmission parameter associated with the second transmission or a disallowed parameter associated with the second transmission.
Aspect 44: The method of either of claim 42 or 43, wherein the at least one transmission parameter comprises at least one of a transmission power, a transmission timing, a modulation and coding scheme, a transmission rank, a precoding matrix, or a target reference signal received power.
Aspect 45: The method of any of Aspects 42-44, wherein the at least one transmission parameter comprises at least one of an associated time range or an associated frequency range.
Aspect 46: The method of Aspect 45, wherein the associated frequency range comprises at least one of a subband, a guard band, or a frequency range associated with a frequency range corresponding to the first transmission.
Aspect 47: The method of any of Aspects 42-46, wherein the at least one transmission parameter is associated with at least one reservation of sidelink transmission resources, including a reservation of the first set of sidelink resources, that satisfies an association condition.
Aspect 48: The method of Aspect 47, further comprising receiving sidelink control information (SCI) including a reservation of a first set of sidelink resources associated with the first transmission, and wherein the at least one reservation satisfies the association condition based on the beam-based FD opportunity announcement being indicated in the SCI.
Aspect 49: The method of either of claim 47 or 48, wherein the at least one reservation satisfies the association condition based on the at least one reservation being associated with a specified resource window.
Aspect 50: The method of any of Aspects 47-49, wherein the specified resource window comprises at least one of a time resource window or a frequency resource window, wherein the at least one of the time resource window or the frequency resource window is defined in relation to at least one of a time resource or a frequency resource used for transmitting the beam-based full duplex opportunity announcement.
Aspect 51: The method of Aspect 50, further comprising receiving an indication of the specified resource window.
Aspect 52: The method of any of Aspects 42-51, wherein the at least one transmission parameter is associated with at least one of a bandwidth part or a component carrier.
Aspect 53: The method of any of Aspects 34-52, wherein receiving the beam-based FD opportunity announcement comprises receiving the beam-based FD opportunity announcement via at least one of a sidelink control information (SCI) part 1, an SCI part 2, a medium access control (MAC) control element (MAC CE), or a radio resource control message.
Aspect 54: The method of any of Aspects 34-52, further comprising transmitting, to the first UE, an acceptance announcement associated with the beam-based FD opportunity announcement.
Aspect 55: The method of Aspect 54, wherein the acceptance announcement indicates a set of transmission parameters associated with the second transmission.
Aspect 56: The method of either of claim 54 or 55, wherein transmitting the acceptance announcement comprises transmitting the acceptance announcement based on a transmission priority associated with the third UE satisfying a priority threshold.
Aspect 57: The method of any of Aspects 54-56, wherein transmitting the acceptance announcement comprises transmitting the acceptance announcement based on a channel measurement associated with the third UE satisfying a channel measurement threshold.
Aspect 58: The method of Aspect 57, wherein the channel measurement comprises at least one of a channel busy ratio or a channel occupancy ratio.
Aspect 59: The method of any of Aspects 54-58, wherein transmitting the acceptance announcement comprises transmitting the acceptance announcement based on a failure to detect an additional conflicted beam-based FD opportunity announcement and an additional resource reservation for sidelink resources indicated in the acceptance announcement.
Aspect 60: The method of any of Aspects 54-59, wherein transmitting the acceptance announcement comprises transmitting an acceptance communication including the acceptance announcement.
Aspect 61: The method of Aspect 60, wherein the acceptance communication comprises at least one of sidelink control information, a medium access control (MAC) control element (MAC CE), or a radio resource control message.
Aspect 62: The method of any of Aspects 34-61, further comprising: transmitting the second transmission to the first UE in association with a first reception beam in a first sidelink resource; and receiving, in full-duplex communication, from the first UE in association with the first transmission beam in a second sidelink resource that is at least partially overlapping in time with the first sidelink resource, in association with the first reception beam and the first transmission beam being compatible for full-duplex communication.
Aspect 63: The method of Aspect 62, wherein the first reception beam is compatible with the first transmission beam-based on satisfaction of a sidelink self-interference condition.
Aspect 64: The method of either of claim 62 or 63, wherein the first reception beam is compatible with the first transmission beam-based on the first transmission beam failing to be indicated by a forbidden transmission indicator.
Aspect 65: The method of Aspect 64, wherein the forbidden transmission indicator corresponds at least one of the first transmission or an additional transmission.
Aspect 66: The method of either of Aspects 64 or 65, wherein the forbidden transmission indicator comprises a binary indicator or an indication of at least one forbidden transmission condition.
Aspect 67: The method of any of Aspects 62-66, further comprising sensing a reservation of the second sidelink resource during a sensing phase.
Aspect 68: An apparatus for wireless communication at a device, comprising a processor; memory coupled with the processor; and instructions stored in the memory and executable by the processor to cause the apparatus to perform the method of one or more of Aspects 1-33.
Aspect 69: A device for wireless communication, comprising a memory and one or more processors coupled to the memory, the one or more processors configured to perform the method of one or more of Aspects 1-33.
Aspect 70: An apparatus for wireless communication, comprising at least one means for performing the method of one or more of Aspects 1-33.
Aspect 71: A non-transitory computer-readable medium storing code for wireless communication, the code comprising instructions executable by a processor to perform the method of one or more of Aspects 1-33.
Aspect 72: A non-transitory computer-readable medium storing a set of instructions for wireless communication, the set of instructions comprising one or more instructions that, when executed by one or more processors of a device, cause the device to perform the method of one or more of Aspects 1-33.
Aspect 73: An apparatus for wireless communication at a device, comprising a processor; memory coupled with the processor; and instructions stored in the memory and executable by the processor to cause the apparatus to perform the method of one or more of Aspects 34-67.
Aspect 74: A device for wireless communication, comprising a memory and one or more processors coupled to the memory, the one or more processors configured to perform the method of one or more of Aspects 34-67.
Aspect 75: An apparatus for wireless communication, comprising at least one means for performing the method of one or more of Aspects 34-67.
Aspect 76: A non-transitory computer-readable medium storing code for wireless communication, the code comprising instructions executable by a processor to perform the method of one or more of Aspects 34-67.
Aspect 77: A non-transitory computer-readable medium storing a set of instructions for wireless communication, the set of instructions comprising one or more instructions that, when executed by one or more processors of a device, cause the device to perform the method of one or more of Aspects 34-67.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
one or more memories; and
one or more processors, coupled to the one or more memories, configured to cause the first UE to:
reserve a first set of sidelink resources for a first transmission to a second UE; and
transmit a beam-based full duplex (FD) opportunity announcement associated with a second transmission that at least partially overlaps the first transmission in time, the beam-based FD opportunity announcement indicating a first transmission beam associated with a third UE.

2. The UE of claim 1, wherein the one or more processors, to cause the first UE to transmit the beam-based FD opportunity announcement, are configured to cause the first UE to transmit first sidelink control information (SCI) that includes the beam-based FD opportunity announcement.

3. The UE of claim 1, wherein the one or more processors, to cause the first UE to reserve the first set of sidelink resources, are configured to cause the first UE to transmit first sidelink control information (SCI) that includes a reservation of the first set of sidelink resources, and wherein the one or more processors, to cause the first UE to transmit the beam-based FD opportunity announcement, are configured to cause the first UE to transmit second SCI that includes the beam-based FD opportunity announcement.

4. The UE of claim 1, wherein the beam-based FD opportunity announcement indicates the third UE based on the beam-based FD opportunity announcement including a UE identifier (ID) associated with the third UE.

5. The UE of claim 1, wherein the beam-based FD opportunity announcement indicates the third UE based on a destination identifier (ID) associated with the first transmission, the destination ID comprising a UE ID of the second UE, wherein a UE ID of the third UE is the same as the UE ID of the second UE.

6. The UE of claim 1, wherein the beam-based FD opportunity announcement indicates the first transmission beam-based on the beam-based FD opportunity announcement including at least one of a transmission configuration indicator (TCI) state identifier (ID) or a reference signal ID, wherein the at least one of the TCI state ID or the reference signal ID is associated with the first UE or the third UE.

7. The UE of claim 1, wherein the beam-based FD opportunity announcement comprises a transmission parameter indication that indicates, in association with at least one of the first transmission beam or a group of allowed transmission beams, at least one transmission parameter associated with the second transmission, wherein the at least one transmission parameter comprises at least one of an allowed transmission parameter associated with the second transmission or a disallowed parameter associated with the second transmission.

8. The UE of claim 7, wherein the at least one transmission parameter comprises at least one of a transmission power, a transmission timing, a modulation and coding scheme, a transmission rank, a precoding matrix, or a target reference signal received power.

9. The UE of claim 7, wherein the at least one transmission parameter comprises at least one of an associated time range or an associated frequency range, the associated frequency range comprising at least one of a subband, a guard band, or a frequency range associated with a frequency range corresponding to the first transmission.

10. The UE of claim 7, wherein the at least one transmission parameter is associated with at least one reservation of sidelink transmission resources, including a reservation of the first set of sidelink resources, that satisfies an association condition.

11. The UE of claim 10, wherein the one or more processors, to cause the first UE to reserve the first set of sidelink resources, are configured to cause the first UE to transmit sidelink control information (SCI) that includes a reservation of the first set of sidelink resources, and wherein the at least one reservation satisfies the association condition based on the beam-based FD opportunity announcement being indicated in the SCI.

12. The UE of claim 10, wherein the at least one reservation satisfies the association condition based on the at least one reservation being associated with a specified resource window, wherein the specified resource window comprises at least one of a time resource window or a frequency resource window, wherein the at least one of the time resource window or the frequency resource window is defined in relation to at least one of a time resource or a frequency resource used for transmitting the beam-based full duplex opportunity announcement.

13. The UE of claim 12, wherein the one or more processors are further configured to cause the first UE to transmit an indication of the specified resource window.

14. The UE of claim 13, wherein the at least one transmission parameter is associated with at least one of a bandwidth part or a component carrier.

15. The UE of claim 1, wherein the one or more processors, to cause the first UE to transmit the beam-based FD opportunity announcement, are configured to cause the first UE to transmit the beam-based FD opportunity announcement via at least one of a sidelink control information (SCI) part 1, an SCI part 2, a medium access control (MAC) control element (MAC CE), or a radio resource control message.

16. The UE of claim 1, wherein the one or more processors are further configured to cause the first UE to receive, from the third UE, an acceptance announcement associated with the beam-based FD opportunity announcement.

17. The UE of claim 16, wherein the acceptance announcement indicates a set of transmission parameters associated with the second transmission.

18. The UE of claim 16, wherein the one or more processors, to cause the first UE to receive the acceptance announcement, are configured to cause the first UE to receive the acceptance announcement based on a transmission priority associated with the third UE satisfying a priority threshold.

19. The UE of claim 16, wherein the one or more processors, to cause the first UE to receive the acceptance announcement, are configured to cause the first UE to receive the acceptance announcement based on a channel measurement associated with the third UE satisfying a channel measurement threshold, wherein the channel measurement comprises at least one of a channel busy ratio or a channel occupancy ratio.

20. The UE of claim 16, wherein the one or more processors, to cause the first UE to receive the acceptance announcement, are configured to cause the first UE to receive the acceptance announcement based on a failure to detect an additional conflicted beam-based FD opportunity announcement and an additional resource reservation for sidelink resources indicated in the acceptance announcement.

21. The UE of claim 16, wherein the one or more processors, to cause the first UE to receive the acceptance announcement, are configured to cause the first UE to receive an acceptance communication including the acceptance announcement, wherein the acceptance communication comprises at least one of sidelink control information, a medium access control (MAC) control element (MAC CE), or a radio resource control message.

22. The UE of claim 1, wherein the one or more processors are further configured to cause the first UE to:
receive the second transmission from the third UE on a first reception beam in a first sidelink resource; and
transmit, in full-duplex communication, to the second UE with the first transmission beam in a second sidelink resource, of the first set of sidelink resources, that is at least partially overlapping in time with the first sidelink resource, in association with the first reception beam and the first transmission beam being compatible for full-duplex communication.

23. The UE of claim 22, wherein the first reception beam is compatible with the first transmission beam-based on satisfaction of a sidelink self-interference condition.

24. The UE of claim 22, wherein the first reception beam is compatible with the first transmission beam-based on the first transmission beam failing to be indicated by a forbidden transmission indicator, wherein the forbidden transmission indicator corresponds to at least one of the first transmission or an additional transmission.

25. A third user equipment (UE) for wireless communication, comprising:
one or more memories; and
one or more processors, coupled to the one or more memories, configured to cause the third UE to:
receive, from a first UE, a beam-based full duplex (FD) opportunity announcement associated with a second transmission, by the third UE to the first UE, that at least partially overlaps a first transmission, from the first UE to a second UE, in time, the beam-based FD opportunity announcement indicating an allowed transmission beam associated with the third UE; and
transmit the second transmission based on receiving the beam-based FD opportunity announcement.

26. The UE of claim 25, wherein the one or more processors are further configured to cause the third UE to:
transmit the second transmission to the first UE in association with a first reception beam in a first sidelink resource; and
receive, in full-duplex communication, from the first UE in association with the first transmission beam in a second sidelink resource that is at least partially overlapping in time with the first sidelink resource, in association with the first reception beam and the first transmission beam being compatible for full-duplex communication.

27. A method of wireless communication performed by a first user equipment (UE), comprising:
reserving a first set of sidelink resources for a first transmission to a second UE; and
transmitting a beam-based full duplex (FD) opportunity announcement associated with a second transmission, by a third UE to the first UE, that at least partially overlaps the first transmission in time, the beam-based FD opportunity announcement indicating a first transmission beam associated with the third UE.

28. The method of claim 27, wherein transmitting the beam-based FD opportunity announcement comprises transmitting first sidelink control information (SCI) that includes the beam-based FD opportunity announcement.

29. A method of wireless communication performed by third user equipment (UE), comprising:
receiving, from a first UE, a beam-based full duplex (FD) opportunity announcement associated with a second transmission, by the third UE to the first UE, that at least partially overlaps a first transmission, from the first UE to a second UE, in time, the beam-based FD opportunity announcement indicating an allowed transmission beam associated with the third UE; and
transmitting the second transmission based on receiving the beam-based FD opportunity announcement.

30. The method of claim 29, further comprising:
transmitting the second transmission to the first UE in association with a first reception beam in a first sidelink resource; and
receiving, in full-duplex communication, from the first UE in association with the first transmission beam in a second sidelink resource that is at least partially overlapping in time with the first sidelink resource, in association with the first reception beam and the first transmission beam being compatible for full-duplex communication.
